(19) United States
(12) Patent Application Publication
(10) Pub. No.: US 2026/0230114 A1
(43) Pub. Date: Aug. 6, 2026

(54) SYSTEM AND METHOD FOR CBF FRAME EXCHANGE

(71) Applicant: NXP USA, Inc., AUSTIN, TX (US)

(72) Inventors: Liwen Chu, San Ramon, CA (US); Rui Cao, Sunnyvale, CA (US); Sudhir Srinivasa, Los Gatos, CA (US); Hongyuan Zhang, Fremont, CA (US); Huizhao Wang, San Jose, CA (US)

(21) Appl. No.: 19/436,320

(22) Filed: Dec. 30, 2025

Related U.S. Application Data
(60) Provisional application No. 63/754,011, filed on Feb. 5, 2025.
(60) Provisional application No. 63/762,285, filed on Feb. 24, 2025.
(60) Provisional application No. 63/817,008, filed on Jun. 3, 2025.
(60) Provisional application No. 63/821,274, filed on Jun. 10, 2025.
(60) Provisional application No. 63/823,278, filed on Jun. 13, 2025.
(60) Provisional application No. 63/829,260, filed on Jun. 24, 2025.

(51) Int. Cl. H04B 7/024

(52) U.S. Cl. CPC H04B 7/024

(57) ABSTRACT

Embodiments of a method and apparatus for wireless communications are disclosed. In an embodiment, a wireless device includes a controller configured to generate frames that carry transmit opportunity (TXOP) duration information in a coordinated beamforming (CBF) TXOP, where the frames include a frame with both a sharing access point (AP)'s address and a shared AP's address and a wireless transceiver configured to wirelessly transmit the frames to announce a duration of the CBF TXOP.

### CROSS-REFERENCE TO RELATED APPLICATIONS

This application is entitled to the benefit of U.S. Provisional Application 63/754,011, filed on Feb. 5, 2025, U.S. Provisional Application 63/762,285, filed on Feb. 24, 2025, U.S. Provisional Application 63/817,008, filed on Jun. 3, 2025, U.S. Provisional Application 63/821,274, filed on Jun. 10, 2025, U.S. Provisional Application 63/823,278, filed on Jun. 13, 2025, and U.S. Provisional Application 63/829,260, filed on Jun. 24, 2025, the contents of each of which are incorporated by reference herein in their entireties.

### BACKGROUND

Wireless communications devices, e.g., access points (APs) or non-AP devices transmit various types of information using different transmission techniques. For example, various applications, such as, Internet of Things (IoT) applications conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) wirelessly transmits data to one or more wireless stations in a non-AP MLD through one or more wireless communications links. Especially in multi-link communications, two APs in a link affiliated with two MLDs wirelessly transmit data to two or more STAs affiliated with two non-AP MLDs that associated with the two AP MLDs, respectively. Some applications, for example, video teleconferencing, streaming entertainment, high definition (HD) video surveillance applications, outdoor video sharing applications, etc., require relatively high system throughput.

### SUMMARY

Embodiments of a method and apparatus for wireless communications are disclosed. In an embodiment, a wireless device includes a controller configured to generate frames that carry transmit opportunity (TXOP) duration information in a coordinated beamforming (CBF) TXOP, where the frames include a frame with both a sharing access point (AP)'s address and a shared AP's address and a wireless transceiver configured to wirelessly transmit the frames to announce a duration of the CBF TXOP. Other embodiments are also disclosed.

In an embodiment, the frame includes a CBF invite that has its duration field covering at least an end time of transmitting a CBF synchronization (SYNC) frame.

In an embodiment, the frame includes a CBF synchronization (SYNC) frame that has its duration field covers an end of the CBF TXOP.

In an embodiment, the CBF SYNC frame includes a buffer status report poll (BSRP) non-trigger based (NTB) frame.

In an embodiment, the frames include an initial control frame (ICF) addressed to at least one associated station (STA) that has a duration field to cover an end time of transmitting an initial control reply (ICR) frame.

In an embodiment, the ICF is transmitted if the at least one addressed STA is an enhanced multi-link single radio (EMLSR) STA or a dynamic power save (DPS) STA to be in a high-capacity (HC) mode for a CBF operation.

In an embodiment, the ICF carries an extended time-out period.

In an embodiment, the extended time-out period is carried in a special user information (Info) field.

In an embodiment, the special user Info field has a value that is higher than 2007.

In an embodiment, the frames include a multi-user (MU)-block acknowledgement request (BAR) addressed to at least one associated station (STA) has a duration field to cover an end time of transmitting a block acknowledgement (BA) frame.

In an embodiment, the MU-BAR carries an extended time-out period.

In an embodiment, the extended time-out period is carried in a feedback per Association Identifier (AID) Traffic Identifier (TID) information (Info) field.

In an embodiment, the sharing AP transmits a contention free-end (CF-End) frame to instruct a station (STA) associated with the sharing AP to reset a timer of the extended time-out period.

In an embodiment, after receiving the sharing AP's CF-End frame, the shared AP transmits the CF-End frame to instruct a STA associated with the shared AP to reset a timer of the extended time-out period.

In an embodiment, a method for wireless communications involves at a wireless device, generating frames that carry transmit opportunity (TXOP) duration information in a coordinated beamforming (CBF) TXOP, where the frames include a frame with both a sharing access point (AP)'s address and a shared AP's address, and from the wireless device, wirelessly transmitting the frames to announce a duration of the CBF TXOP.

In an embodiment, the frame includes a CBF invite that has its duration field covering at least an end time of transmitting a CBF synchronization (SYNC) frame.

In an embodiment, the frame includes a CBF synchronization (SYNC) frame that has its duration field covers an end of the CBF TXOP.

In an embodiment, the CBF SYNC frame includes a buffer status report poll (BSRP) non-trigger based (NTB) frame.

In an embodiment, the frames include an initial control frame (ICF) addressed to at least one associated station (STA) that has a duration field to cover an end time of transmitting an initial control reply (ICR) frame.

In an embodiment, the ICF is transmitted if the at least one addressed STA is an enhanced multi-link single radio (EMLSR) STA or a dynamic power save (DPS) STA to be in a high-capacity (HC) mode for a CBF operation.

Other aspects in accordance with the disclosure will become apparent from the following detailed description, taken in conjunction with the accompanying drawings, illustrated by way of example of the principles of the disclosure.

### BRIEF DESCRIPTION OF THE DRAWINGS

FIG. 1 depicts a wireless communications system in accordance with example embodiments.

FIG. 2 depicts a multi-link (ML) communications system that is used for wireless communications in accordance with example embodiments.

FIG. 3 depicts a wireless device in accordance with example embodiments.

FIG. 4 illustrates some communications between a sharing AP, a shared AP, and two stations (STAs) in a two-stage Coordinated beamforming (CBF) Transmit opportunity (TXOP) in accordance with example embodiments.

FIG. 5 illustrates a frame that carries an extended time-out period in accordance with an embodiment of the disclosure.

FIG. 6 illustrates some extended time-out periods of STAs depicted in FIG. 4 in accordance with example embodiments.

FIG. 7 illustrates some extended time-out periods of the STAs depicted in FIG. 4 in accordance with example embodiments.

FIG. 8 illustrates a Feedback User Info field format in accordance with example embodiments.

FIG. 9 illustrates some extended time-out periods of the STAs depicted in FIG. 4 in accordance with example embodiments.

FIG. 10 illustrates some extended time-out periods of the STAs depicted in FIG. 4 in accordance with example embodiments.

FIG. 11 illustrates some extended time-out periods of the STAs depicted in FIG. 4 in accordance with example embodiments.

FIG. 12 illustrates some TXOP durations set by the sharing AP in the CBF TXOP depicted in FIG. 4 in accordance with example embodiments.

FIG. 13 is a process flow diagram of a method for wireless communications in accordance with example embodiments.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description herein, that the disclosure can be practiced without one or more of the specific features or advantages of a particular embodiment. In other instances, additional features and advantages may be recognized in certain embodiments that may not be present in all embodiments of the disclosure.

Reference throughout this specification to “one embodiment”, “an embodiment”, or similar language means that a particular feature, structure, or characteristic described in connection with the indicated embodiment is included in at least one embodiment of the present disclosure. Thus, the phrases “in one embodiment”, “in an embodiment”, and similar language throughout this specification may, but do not necessarily, all refer to the same embodiment.

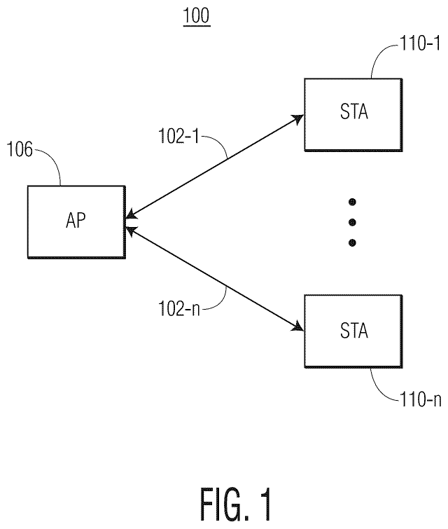

FIG. 1 depicts a wireless (e.g., WiFi) communications system 100 in accordance with an embodiment of the disclosure. In the embodiment depicted in FIG. 1, the wireless communications system 100 includes at least one AP 106 and at least one station (STA) 110-1, . . . , 110-n that perform frame exchanges in at least one communication link 102-1, . . . , 102-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the AP 106 may be affiliated with an AP MLD, and a STA 100-j with j being an integer equal to one of 1 to n may be affiliated with a STA MLD j (=non-AP MLD j).

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received physical layer protocol data units (PPDUs) through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon, association establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements upper layer MAC functionalities and lower layer MAC layer functionalities. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received PPDUs through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via at least one communication link 102-1, . . . , 102-n, where n is a positive integer. In some embodiments, data communicated between the AP and the at least one STA 110-1, . . . , 110-n includes MAC protocol data units (MPDUs). An MPDU (frame) may include a frame header, a frame body, and a trailer with the MAC service data unit (MSDU) payload, Aggregated MAC Service Data Unit (A-MSDU), or MMPDU (Management MAC Protocol Data Unit) encapsulated in the frame body.

In some embodiments of a wireless communications system, a wireless device, e.g., an access point (AP) multi-link device (MLD) of a wireless local area network (WLAN) may transmit a data frame, a Management frame, and/or a Control frame to at least one associated station (STA) MLD. The AP MLD may be configured to operate with associated STA MLDs according to a communication protocol. For example, the communication protocol may be an Ultra High Reliability (UHR) communication protocol, or an Institute of Electrical and Electronics Engineer (IEEE) 802.11 communication protocol (e.g., an IEEE 802.11bn communication protocol). In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., Extremely High Throughput (EHT) communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

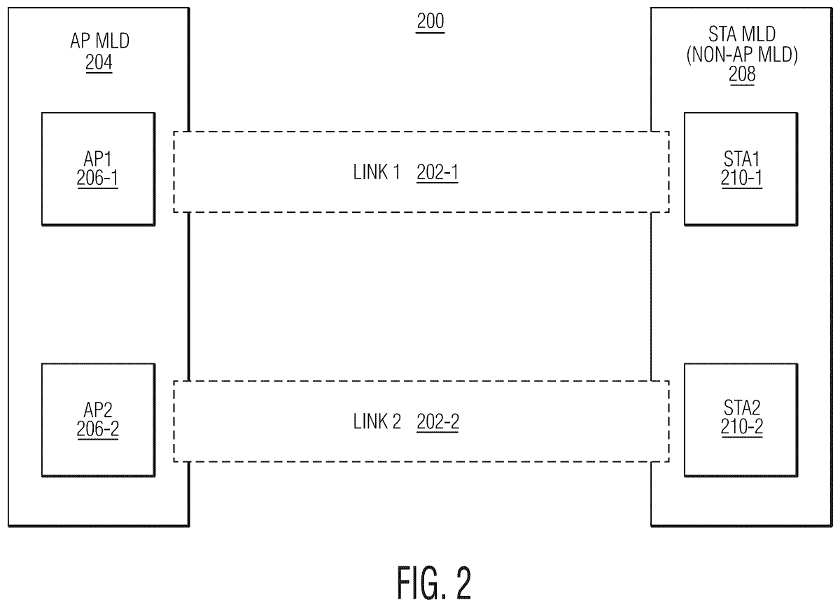

FIG. 2 depicts a multi-link (ML) communications system 200 that is used for wireless (e.g., WiFi) communications in accordance with an embodiment of the disclosure. In the embodiment depicted in FIG. 2, the multi-link communications system includes one AP multi-link device, which is implemented as AP MLD 204, and one non-AP STA multi-link device, which is implemented as STA MLD (non-AP MLD) 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities that are common to multiple links (e.g., association establishment, reordering of frames, etc.) and a link specific part of the AP MLD 204, i.e., the APs 206-1 and 206-2, implement upper layer functionalities specific to a link and the lower layer MAC functionalities (e.g., Beaconing, backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received PPDUs through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHz BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an IEEE 802.11bn protocol, an IEEE 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup (multi-link association) phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received PPDUs through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., beacon frames, management frames, etc., in Physical Layer Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit MLD-level management frames in a multi-link operation with a second MLD, e.g., STA MLD or AP MLD, to coordinate the multi-link operation between the first MLD and the second MLD. As an example, a management frame may be a TID-to-Link Mapping Request frame (TID stands for Traffic Identifier), a TID-to-Link Mapping Response frame, a (Re)Association Request frame, a (Re)Association Response frame, a Disassociation frame, an Authentication frame, and/or a Block Acknowledgement (Ack) (BA) Action frame, etc. In some embodiments, an AP/STA of a first MLD may transmit link-level management frames for a link to a STA/AP of a second MLD. In some embodiments, one or more link-level management frames may be transmitted via a cross-link transmission (e.g., according to an IEEE 802.11bn communication protocol). As an example, a cross-link management frame transmission may involve a management frame being transmitted and/or received on one link (e.g., the link 1 202-1) while carrying information of another link (e.g., the link 2 202-2). In some embodiments, a management frame is transmitted on any link (e.g., at least one of two links or at least one of multiple links) between a first MLD (e.g., the AP MLD 204) and a second MLD (e.g., the STA MLD 208). As an example, a management frame may be transmitted between a first MLD and a second MLD on any link (e.g., at least one of two links or at least one of multiple links) associated with the first MLD and the second MLD.

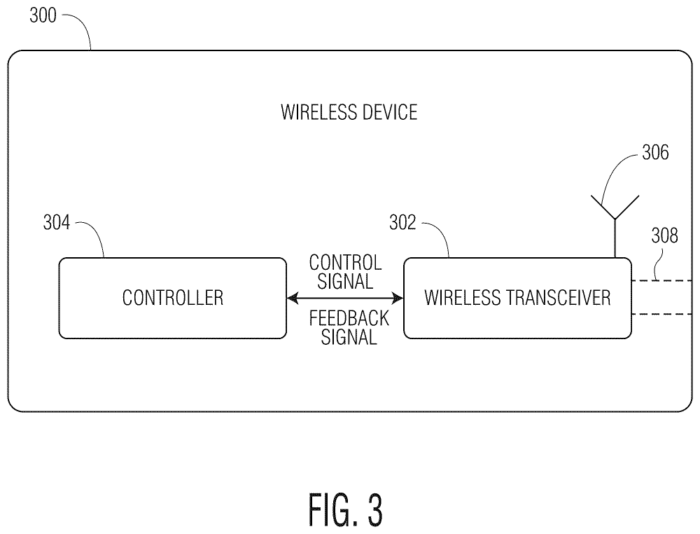

FIG. 3 depicts a wireless device 300 in accordance with an embodiment of the disclosure. The wireless device 300 can be used in the wireless communications system 100 depicted in FIG. 1 and/or the multi-link communications system 200 depicted in FIG. 2 for each link independently. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process PPDUs received through the antenna and/or the network port and/or to generate outgoing PPDUs to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

To facilitate the proper information transmission/exchange within a wireless communications system, there is a need for wireless communications technology that can efficiently and securely convey wireless communications information, for example, information related to data, communications links, and/or wireless devices (e.g., operation and/or capability parameters of wireless devices) within the wireless communications system.

Coordinated beamforming (CBF) is a wireless communication technique in which multiple wireless access points (APs) coordinate their beamforming efforts to reduce interference and improve performance, particularly for users at coverage edges. For example, using CBF, multiple APs can simultaneously communicate with multiple stations (STAs) wirelessly on the same frequency band. CBF may involve multiple APs beamforming together by creating constructive interference (peaks) for target STAs or users and destructive interference (nulls) in the direction of other STAs or users to minimize interference, resulting in better coverage, higher data rates, and improved system throughput. For example, an AP may act as a sharing AP that shares a transmission opportunity (TXOP) with a coordinated AP or a shared AP to perform CBF transmissions.

In accordance with an embodiment of the disclosure, the controller 304 is configured to generate frames that carry transmit opportunity (TXOP) duration information in a coordinated beamforming (CBF) TXOP, where the frames include a frame with both a sharing access point (AP)'s address and a shared AP's address, and the wireless transceiver 302 is configured to wirelessly transmit the frames to announce a duration of the CBF TXOP.

In some embodiments, the frame includes a CBF invite that has its duration field covering at least an end time of transmitting a CBF synchronization (SYNC) frame.

In some embodiments, the frame includes a CBF synchronization (SYNC) frame that has its duration field covers an end of the CBF TXOP.

In some embodiments, the CBF SYNC frame includes a buffer status report poll (BSRP) non-trigger based (NTB) frame.

In some embodiments, the frames include an initial control frame (ICF) addressed to at least one associated station (STA) that has a duration field to cover an end time of transmitting an initial control reply (ICR) frame.

In some embodiments, the ICF is transmitted if the at least one addressed STA is an enhanced multi-link single radio (EMLSR) STA or a dynamic power save (DPS) STA to be in a high-capacity (HC) mode for a CBF operation.

In some embodiments, the ICF carries an extended time-out period.

In some embodiments, the extended time-out period is carried in the special user information (Info) field.

In some embodiments, the special user Info field has a value that is higher than 2007.

In some embodiments, the frames include a multi-user (MU)-block acknowledgement request (BAR) addressed to at least one associated station (STA) has a duration field to cover an end time of transmitting a block acknowledgement (BA) frame.

In some embodiments, the MU-BAR carries an extended time-out period.

In some embodiments, the extended time-out period is carried in a feedback per Association Identifier (AID) Traffic Identifier (TID) information (Info) field.

In some embodiments, the sharing AP transmits a contention free-end (CF-End) frame to instruct a station (STA) associated with the sharing AP to reset a timer of the extended time-out period.

In some embodiments, after receiving the sharing AP's CF-End frame, the shared AP transmits the CF-End frame to instruct a STA associated with the shared AP to reset a timer of the extended time-out period.

In accordance with an embodiment of the disclosure, the controller 304 is configured to generate a message (CBF Transmission Invite frame, or CBF Transmission Response) that carries an Acknowledgement exchange time requirement, an ICF/ICR frame exchange time requirement during a coordinated beamforming (CBF) transmission preparing handshake, and the extended time-out period is calculated per the Acknowledgement exchange time requirement, an ICF/ICR frame exchange time requirement. For example, a CBF transmission sequence may involve coordinated transmissions and receptions, which can have specific inactivity periods that are longer than inactivity periods during normal operations. An extended time-out period can be used, for example, to ensure that the wireless station does not prematurely switch back to the listen mode and potentially disrupt the ongoing CBF sequence by starting its own transmission. The duration of an extended time-out period is sufficient to cover potential inactivity phases within the CBF transmission sequence. For example, once the CBF transmission sequence is complete and the wireless station switches back to the listen mode, the wireless station can revert to using default time-out periods, unless otherwise instructed.

In accordance with an embodiment of the disclosure, the controller 304 is configured to generate a message that carries an extended time-out period after a coordinated beamforming (CBF) transmission preparing handshake, and the wireless transceiver 302 is configured to wirelessly transmit the message to a wireless station (STA) to announce the extended time-out period to the wireless STA during a CBF transmit opportunity (TXOP), for example, through the at least one antenna 306.

In some embodiments, the wireless device 300 includes a sharing wireless access point (AP) that shares the CBF TXOP, and the wireless STA is associated with the sharing wireless AP.

In some embodiments, the wireless device 300 includes a shared wireless access point (AP) with which the CBF TXOP is shared, and the wireless STA is associated with the shared wireless AP.

In some embodiments, the message includes an initial control frame (ICF), which includes a special User information (Info) field that carries the extended time-out period.

In some embodiments, the special User Info field has a value that is higher than 2007 in an Association Identifier (AID) 12 field.

In some embodiments, the wireless STA sets an extended time-out timer using the extended time-out period, and before the extended time-out timer times out, the wireless STA is in a frame exchange mode.

In some embodiments, the CBF Transmission Invite frame includes a buffer status report poll (BSRP) trigger frame.

In some embodiments, the CBF Transmission Response message includes a Multi-Link BlockAck (BA) frame, which includes a special Per Association Identifier (AID) Traffic Identifier (TID) information (Info) (Per AID TID Info) field.

In some embodiments, the special Per AID TID Info field has a value that is higher than 2007 in an AID 11 field.

In some embodiments, the wireless STA sets an extended time-out timer using the extended time-out period, and before the extended time-out timer times out, the wireless STA is in a frame exchange mode.

In some embodiments, the ICF frame for soliciting STA's switch to the state of frame exchange readiness includes a buffer status report poll (BSRP) trigger frame, a multi-user (MU)-Request to send (RTS), or an RTS. In some embodiments, the ICR (Initial Control Reply) frame for announcing STA's state of frame exchange readiness includes a Multi-STA BA frame, or a clear to send (CTS). In some embodiments, the ICF carries the extended time-out period.

In some embodiments, the controller 304 is further configured to generate a Contention Free (CF)-End message, and the wireless transceiver 302 is further configured to wirelessly transmit the CF-End message to the wireless STA, which reset an extended timeout timer after receiving the CF-End message.

In some embodiments, the wireless device 300 is compatible with an Institute of Electrical and Electronics Engineers (IEEE) 802.11 protocol.

In some embodiments, the wireless device 300 is associated with a wireless multi-link device (MLD). In some embodiments, the wireless device 300 includes a wireless multi-link device (MLD), and the wireless transceiver 302 in a wireless link of the wireless MLD is further configured to conduct frame exchanges (for example, taking part in the operation or management of frame exchanges, such as to transmit and receive frames) with a second wireless MLD through the wireless link between the wireless MLD and the second wireless MLD.

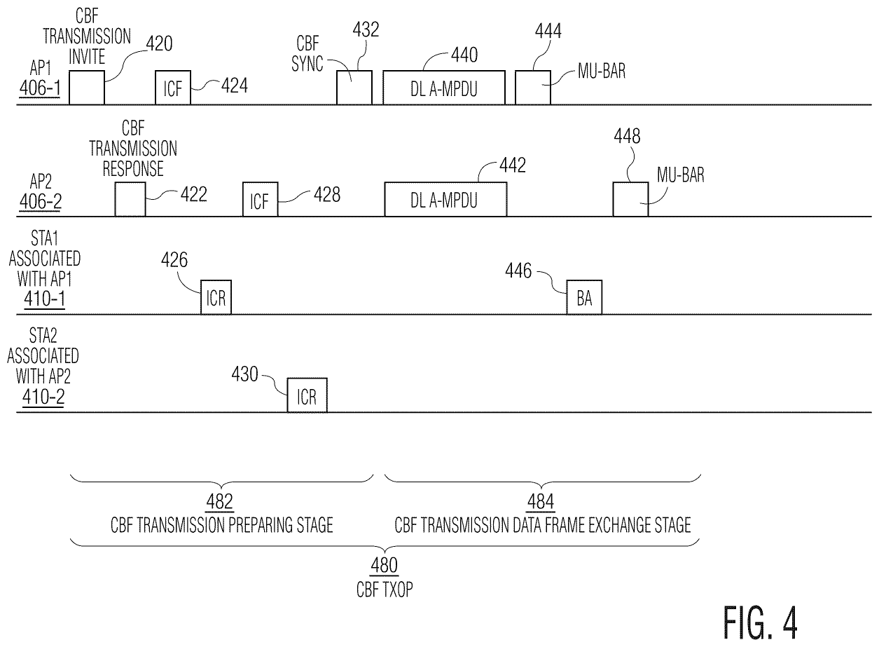

FIG. 4 illustrates some communications between a sharing AP 406-1, a shared AP 406-2, and two stations (STAs) 410-1, 410-2 in a two-stage Coordinated beamforming (CBF) Transmit opportunity (TXOP) 480 in accordance with example embodiments. In some embodiments, the sharing AP 406-1, which is also referred to as AP1, shares the CBF TXOP 480 with the shared AP 406-2 and the shared AP 406-2, which is also referred to as AP2, is an AP with which the CBF TXOP 480 is shared. In some embodiments, the STA 410-1, which is also referred to as STA1, associates with the sharing AP 406-1 and the STA 410-2, which is also referred to as STA2, associates with the shared AP 406-2. As illustrated in FIG. 4, the two-stage CBF TXOP 480 includes a CBF transmission preparing stage 482 (also referred to as a polling stage) and a CBF transmission data frame exchange stage (also referred to as a CBF PPDUs transmission (Tx)/Reception (Rx) stage) 484. In some embodiments, the CBF transmission preparing stage/polling stage 482 does not assume that the shared AP 406-1 supports trigger based (TB) PPDU transmission. The sharing AP 406-1 and/or the shared AP 406-2 depicted in FIG. 4 may be the same as or similar to an embodiment of the AP 106 depicted in FIG. 1, the APs 206-1, 206-2 depicted in FIG. 2, and/or the wireless device 300 depicted in FIG. 3. The STA 410-1 and/or the STA 410-2 depicted in FIG. 4 may be the same as or similar to an embodiment of the STA 110-1, . . . , or 110-n depicted in FIG. 1, the STA 210-1 or 210-32 depicted in FIG. 2, and/or the wireless device 300 depicted in FIG. 3.

As illustrated in FIG. 4, in a time sequence during the CBF transmission preparing stage 482, the sharing AP (AP1) 406-1 transmits a CBF transmission invite/invitation 420 to the shared AP (AP2) 406-2 and the shared AP (AP2) 406-2 transmits a CBF transmission response 422 to the sharing AP (AP1) 406-1. In some embodiments, besides the sharing AP's associated STAs that join the CBF transmission, etc., the CBF Transmission Invite frame may carry the ICF/ICR exchange time requirement, the acknowledgement procedure time requirement. In some embodiments, besides the sharing AP's associated STAs that join the CBF transmission, etc., the CBF Transmission Response frame may carry the ICF/ICR exchange time requirement, the acknowledgement procedure time requirement, the padding requirement in a CBF SYNC frame for the shared AP's preparing of CBF PPDU (442) transmission. Subsequently, the sharing AP (AP1) 406-1 transmits an Initial Control Frame (ICF) 424 to the STA (STA1) 410-1 and the STA (STA1) 410-1 transmits an initial control response (ICR) 426 (e.g., carried in a TB PPDU or non-TB PPDU) to the sharing AP (AP1) 406-1 if/when the ICF/ICR exchange helps the readiness of STA1's data frame reception. The shared AP (AP2) 406-2 transmits an ICF 428 to the STA (STA2) 410-2 and the STA (STA2) 410-2 transmits an ICR 430 (e.g., embedded or carried in a TB PPDU or non-TB PPDU) to the shared AP (AP2) 406-2 if/when the ICF/ICR exchange helps the readiness of STA2's data frame reception. In some embodiments, the ICF/ICR is required if the STA that joins the CBF transmission is an EMLSR (Enhanced Multi-Link Single Radio) STA or a STA in a DPS (Dynamic Power Save) mode and the associated AP solicits the STA's switch its high capability mode for the frame reception within a CBF transmission stage. In some embodiments, the sharing AP (AP1) 406-1 or the shared AP (AP2) 406-2 may not send an ICF to its associated STA in a DPS mode with ICF Required equal to 0 if the AP transmits frames in the CBF transmission stage to the STA using STA's parameters (Modulation Coding Scheme (MCS), Number of Spatial Streams (Nss)) of the low capability mode. Subsequently, the sharing AP (AP1) 406-1 transmits a CBF synchronization (SYNC) message 432 to synchronize the downlink (DL) MU PPDU transmission from both the sharing AP (AP1) 406-1 and the shared AP (AP2) 406-2. In some embodiments, the CBF SYNC frame is a Buffer Status Report Poll (BSRP) non-trigger based NTB frame. In some embodiments, the CBF SYNC carries the padding requested by the shared AP (AP2) 406-2. In some embodiments, the padding in the CBF SYNC frame is used for the shared AP to prepare the transmission of the DL Aggregated MAC Protocol Data Unit (A-MPDU) 442. In some embodiments, the CBF SYNC frame carries the time requirement of the frame exchange for the sharing AP to acquire the BA.

Subsequently, as illustrated in FIG. 4, in a time sequence during the CBF transmission data frame exchange stage 484 that is synchronized/triggered by the CBF SYNC frame, the sharing AP (AP1) 406-1 transmits a downlink (DL) Aggregated MAC Protocol Data Unit (A-MPDU) 440 and the shared AP (AP2) 406-2 transmits a DL A-MPDU 442. Subsequently, the sharing AP (AP1) 406-1 transmits a Multi-user (MU)-block acknowledgement request (BAR) 444 to solicit the various BA (e.g., compressed BA or Multi-STA BA) from the STA (STA1) 410-1 and the STA (STA1) 410-1 transmits a block acknowledgement (BA) 446 to the sharing AP (AP1) 406-1. Subsequently, the shared AP (AP2) 406-2 transmits a MU-BAR 448 to solicit the various BA (e.g., compressed BA or Multi-STA BA) from the STA (STA2) 410-2 and the STA (STA2) 410-2 transmits a block acknowledgement (BA) 450 to the shared AP (AP2) 406-2.

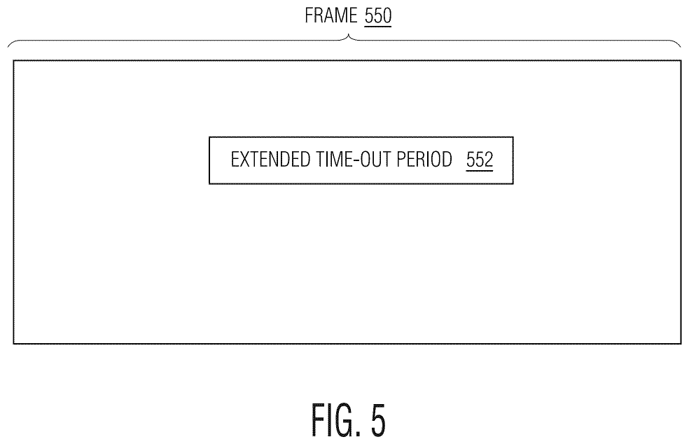

FIG. 5 illustrates a frame 550 that carriers an extended time-out period 552 in accordance with an embodiment of the disclosure. The frame 550 illustrated in FIG. 5 can be used for communications by the wireless communications system 100 depicted in FIG. 1, the multi-link (ML) communications system 200 depicted in FIG. 2, the wireless device 300 depicted in FIG. 3, and the sharing AP (AP1) 406-1, the shared AP (AP2) 406-2, the STA (STA1) 410-1, and/or the STA (STA2) 410-2 depicted in FIG. 4. In the embodiment depicted in FIG. 5, the frame 550 includes a field in the frame body that contains the extended time-out period 552. In some embodiments, the extended time-out period is announced to a wireless STA that sets an extended time-out timer using the extended time-out period after switching to a frame exchange mode/state with full operating parameters from an EMLSR listening operation or a DPS low-capacity (LC) mode, and before the extended time-out timer times out, the wireless STA is in a frame exchange mode with the full operating parameters. In some embodiments, the frame is an initial control frame (ICF), which includes a special User information (Info) field that carries the extended time-out period. In some embodiments, the special User Info field has a value that is higher than 2007 in an Association Identifier (AID) 12 field. In some embodiments, the ICF is a buffer status report poll (BSRP) NTB trigger frame or a multi-user (MU)-Request to send (RTS). In some embodiments, the message includes a MU-Block Acknowledgement Request (BAR), which includes a special Per Association Identifier (AID) Traffic Identifier (TID) information (Info) field that carries the extended time-out period. In some embodiments, the special Per AID TID Info field has a value that is higher than 2007 in an AID 11 field.

In some embodiments, a CBF Synchronization (Sync) frame reuses a buffer status report poll (BSRP) NTB Trigger frame or a multi-user (MU)-Request to send (RTS) with a reserved bit in a Common information (Info) field or an IEEE 802.11be's Special User Info field to be repurposed as a CBF Sync indication. In some embodiments, the CBF SYNC frame carries the padding requested by the shared AP (AP2) 406-2. In some embodiments, the padding in the CBF SYNC frame is used for the shared AP to prepare the transmission of the DL A-MPDU 442. In some embodiments, the CBF SYNC frame carries the time requirement of the frame exchange for the sharing AP to acquire the BA.

In some embodiments, the acknowledgement of CBF PPDUs are always sequential. In some embodiments, when a CBF PPDU is a 20 MHz PPDU, the acknowledgement of CBF PPDUs are always sequential.

In some embodiments, after determining the end time of the sharing AP's reception of BA, the shared AP sends its MU-BAR. In some embodiments, the end time of the sharing AP's reception of BA is decided by Short Interframe Space (SIFS) plus the duration of the uplink (UL) TB PPDU carrying the BA that is indicated in MU-BAR. In some embodiments, the end time of the sharing AP's reception of BA is decided by the time requirement of the frame exchange for the sharing AP to acquire the BA carried in a CBF SYNC frame.

In some embodiments, after receiving an acknowledgement from its associated STA, a sharing AP notifies a shared AP to send its BAR. In some embodiments, only MU-BAR is used by the sharing AP and shared AP to solicit BA. In some embodiments, the MU-BAR polling notification is done or implemented through an MU-RTS TXS (triggered TXOP sharing).

Some implementations of a Sequential Acknowledgement, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In an observation, a third-party STA cannot decode the PHY header of a trigger-based (TB) PPDU that carries the BA if the TB PPDU's bandwidth (BW) is 20 MHz because BSS color transmitted by two STAs that are associated with both the sharing AP and the shared AP since the BSS color that being carried in the TB PPDU have different values.

In some embodiments, a sequential acknowledgement is used.

In some embodiments, each Quality of Service (QoS) Data frame in a sharing AP's A-MPDU has an Ack Policy field equal to 00 (Normal Ack and Implicit BAR), 01(HETP (High Efficiency Technical Protocol) Ack), 11 (Block Ack). In some embodiments, each QoS Data frame in the sharing AP's A-MPDU has the Ack Policy field equal to 01(HETP (High Efficiency Technical Protocol). In some embodiments, each QoS Data frame in the sharing AP's A-MPDU has the Ack Policy field equal to 11 (Block Ack).

In some embodiments, each QoS Data frame in a sharing AP's A-MPDU has the Ack Policy field equal to 01(HETP (High Efficiency Technical Protocol). In some embodiments, each QoS Data frame in a shared AP's A-MPDU has an Ack Policy field equal to 11 (Block Ack).

In some embodiments, the shared AP decides the time of its MU-BAR transmission based on the sharing AP's indication. For example, such information is carried in an MU-BAR of the sharing AP, i.e., the Short Interframe Space (SIFS) pls the length of a responding TB PPDU carrying the BA. In some embodiments, the end time of the sharing AP's reception of BA is decided by the time requirement of the frame exchange for the sharing AP to acquire the BA carried in a CBF SYNC frame.

Some implementations of Keeping in Frame Exchange Mode, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In an observation, a STA may receive one or more frame(s) that are not addressed to it in the CBF preparing stage and the acknowledging stage within the CBF transmission phase. A STA in an Enhanced Multi-Link Single Radio (eMLSR) link or a DPS STA in a low-capacity (LC) mode that is associated with an AP needs to stay in a frame exchange mode until the simultaneous DL CBF PPDUs with the A-MPDU addressed to the STA or until the MU-BAR addressed to it.

In some embodiments, in solution 1, a sharing AP and a shared AP announce the TXOP duration. A STA in an eMLSR link or in an LC mode that joins CBF frame exchanges needs to stay in a frame exchange mode until the time when it transmits a BA/Ack or the end of the TXOP. In some embodiments, the STA ignores the carrier sense (CS) required in the TXOP for CBF transmission.

In some embodiments, in solution 2, an ICF (e.g., a BSRP Trigger or an MU-RTS as the ICF) carries an extended time-out period in a special User Info field with >2007 value in its AID12 (AID stands for Association Identifier (ID)) field. In some embodiments, each AP notifies the extended time-out period in a special User Info field of a BSRP or an MU-RTS with >2007 value in its AID12 field frame to its associated STA if required. In some embodiments, the extend time-out period is used to set an extended time-out timer by the EMLSR/DPS STA associated with the sharing AP and the shared AP that starts after a response is transmitted by the EMLSR/DPS STA associated with the sharing AP and the shared AP. In some embodiments, the extend time-out period is used to set an extended time-out timer that starts after the simultaneous DL PPDU addressed to the EMLSR/DPS STA associated with the shared AP. In some embodiments, before the extended time-out timer times out, the STA is in a frame exchange mode for EMLSR or a high-capacity (HC) mode for Dynamic Power Save (DPS).

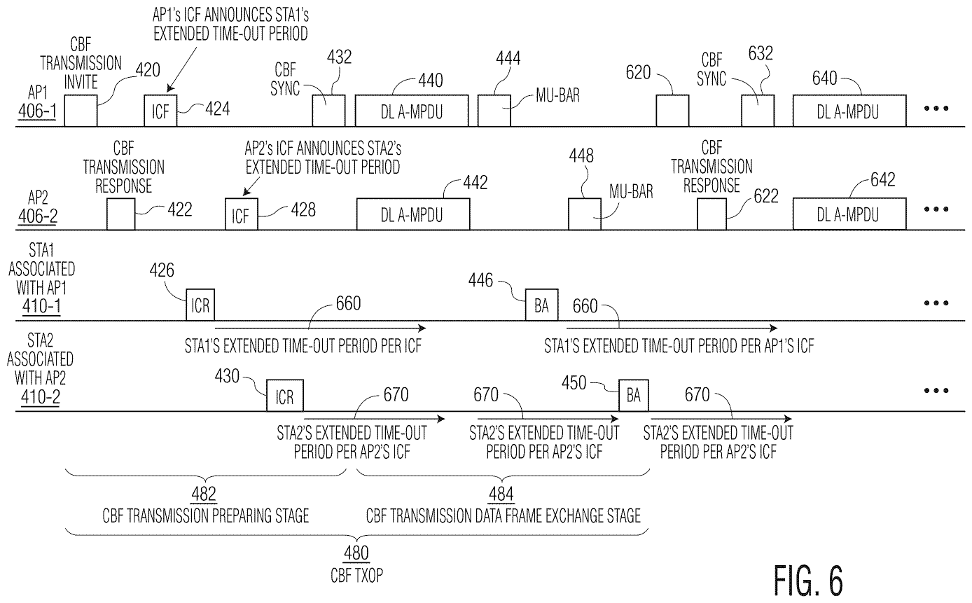

FIG. 6 illustrates some extended time-out periods 660, 670 of the STA (STA1) 410-1 and the STA (STA2) 410-2 depicted in FIG. 4 in accordance with example embodiments. As illustrated in FIG. 6, the sharing AP (AP1) 406-1's ICF 424 (e.g., a BSRP Trigger or an MU-RTS as the ICF) announces the STA (STA1) 410-1's extended time-out period (e.g., carried in a special User Info field, for example, with >2007 value, in its AID12 field) and the STA (STA1) 410-1's extended time-out period 660 is set per the sharing AP (AP1) 406-1's ICF 424, when the STA (STA1) 410-1 finishes the transmission of the ICR 426 (e.g., embedded or carried in a TB PPDU) to the sharing AP (AP1) 406-1 or when STA1 410-1 finishes the transmission of BA 446. The shared AP (AP2) 406-2's ICF 428 (e.g., a BSRP Trigger or an MU-RTS as the ICF) announces the STA (STA2) 410-2's extended time-out period (e.g., carried in a special User Info field, for example, with >2007 value, in its AID12 field) and the STA (STA2) 410-2's extended time-out period 670 is set per the shared AP (AP2) 406-2's ICF 428, when the STA (STA2) 410-2 finishes the transmission of the ICR 430 (e.g., embedded or carried in a TB PPDU) to the shared AP (AP2) 406-2. In some embodiments, the extend time-out period 660 or 670 is used to set an extended time-out timer by the EMLSR/DPS STA associated with the sharing AP or the shared AP that may start after a response (ICR or BA) is transmitted entirely by the EMLSR/DPS STA associated with the sharing AP and the shared AP. In some embodiments, the extend time-out period is used to set an extended time-out timer that starts after the simultaneous DL PPDU addressed to the EMLSR/DPS STA associated with the shared AP. In some embodiments, before an extended time-out timer times out, the STA (STA1) 410-1 or the STA (STA2) 410-2 is in a frame exchange mode for EMLSR or in a high-capacity (HC) mode for Dynamic Power Save (DPS). As illustrated in FIG. 6, the sharing AP (AP1) 406-1 transmits a CBF transmission invite/invitation 620 to the shared AP (AP2) 406-2 and the shared AP (AP2) 406-2 transmits a CBF transmission response 622 to the sharing AP (AP1) 406-1. Subsequently, the sharing AP (AP1) 406-1 transmits a CBF synchronization (SYNC) message 632 to synchronize the DL MU PPDU transmission from both the sharing AP (AP1) 406-1 and the shared AP (AP2) 406-2. Subsequently, as illustrated in FIG. 6, the sharing AP (AP1) 406-1 transmits a downlink (DL) Aggregated MAC Protocol Data Unit (A-MPDU) 640 and the shared AP (AP2) 406-2 transmits a DL A-MPDU 642.

In some embodiments, in solution 3, an ICF (e.g., a BSRP Trigger or an MU-RTS as the ICF) carries the duration in an extended time-out period User Info field with >2007 value in its AID12 field. In some embodiments, each AP notifies the extended time-out period value in a special User Info field of a BSRP or an MU-RTS with >2007 value in its AID12 field frame to its associated STA if required. In some embodiments, an MU-BAR carries the extended time-out period in a special User Info field with >2007 value in its AID12 field. In some embodiments, each AP notifies the extended time-out period value in a special User Info field of an ICF (e.g., BSRP or an MU-RTS) and a MU-BAR with >2007 value in its AID12 field frame to its associated STA if required. In some embodiments, if/when the ICF/ICR exchange fails, the error recovery will not be performed. In some embodiments, if/when MU-BAR and Block Ack exchange fails, the error recovery will not be performed.

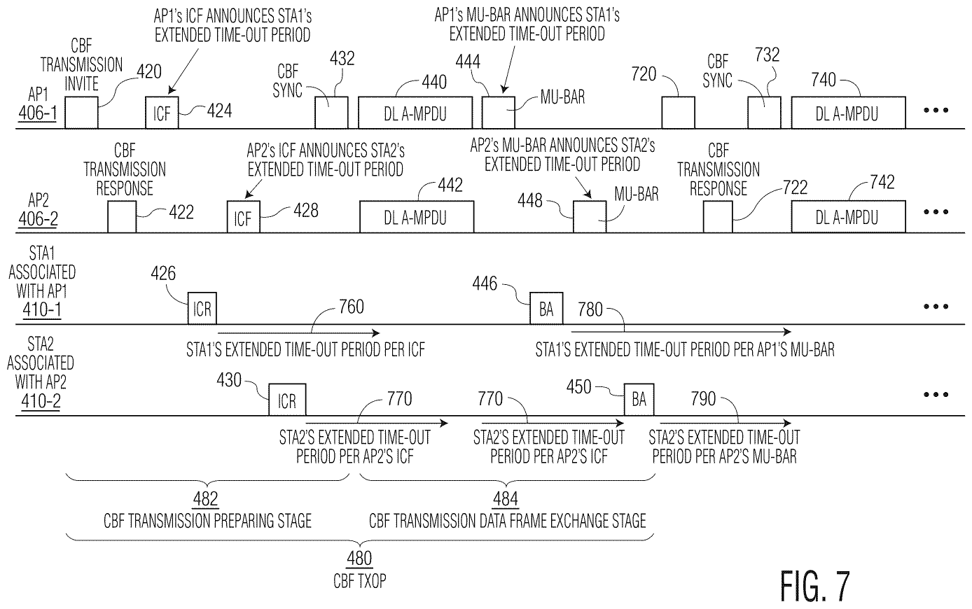

FIG. 7 illustrates some extended time-out periods 760, 770, 780, 790 of the STA (STA1) 410-1 and the STA (STA2) 410-2 depicted in FIG. 4 in accordance with example embodiments. As illustrated in FIG. 7, the sharing AP (AP1) 406-1's ICF 424 (e.g., a BSRP Trigger or an MU-RTS as the ICF) announces the STA (STA1) 410-1's extended time-out period (e.g., carried in a special User Info field, for example, with >2007 value, in its AID12 field) and the STA (STA1) 410-1's extended time-out period 760 is set per the sharing AP (AP1) 406-1's ICF 424, when the STA (STA1) 410-1 finishes the transmission of the ICR 426 (e.g., embedded or carried in a trigger-based (TB) PPDU) to the sharing AP (AP1) 406-1. The shared AP (AP2) 406-2's ICF 428 (e.g., a BSRP Trigger or an MU-RTS as the ICF) announces the STA (STA2) 410-2's extended time-out period (e.g., carried in a special User Info field, for example, with >2007 value, in its AID12 field) and the STA (STA2) 410-2's extended time-out period 770 is set per the shared AP (AP2) 406-2's ICF 428, when the STA (STA2) 410-2 finishes the transmission of the ICR 430 (e.g., embedded or carried in a TB PPDU) to the shared AP (AP2) 406-2 or after the STA (STA2) finishes the reception of DL A-MPDU 442. As illustrated in FIG. 7, the sharing AP (AP1) 406-1's MU-BAR 444 announces the STA (STA1) 410-1's extended time-out period (e.g., carried in a special Per AID TID Info field, for example, with >2007 value, in its AID11 field) and the STA (STA1) 410-1's extended time-out period 780 is set per the sharing AP (AP1) 406-1's MU-BAR 444, when the STA (STA1) 410-1 finishes the transmission of the BA 446 (e.g., embedded or carried in a TB PPDU) to the sharing AP (AP1) 406-1. The shared AP (AP2) 406-2's MU-BAR 448 announces the STA (STA2) 410-2's extended time-out period (e.g., carried in a special Per AID TID Info field, for example, with >2007 value, in its AID11 field) and the STA (STA2) 410-2's extended time-out period 790 is set per the shared AP (AP2) 406-2's MU-BAR 448, when the STA (STA2) 410-2 finishes the transmission of the BA 450 (e.g., embedded or carried in a TB PPDU) to the shared AP (AP2) 406-2. As illustrated in FIG. 7, the sharing AP (AP1) 406-1 transmits a CBF transmission invite/invitation 720 to the shared AP (AP2) 406-2 and the shared AP (AP2) 406-2 transmits a CBF transmission response 722 to the sharing AP (AP1) 406-1. Subsequently, the sharing AP (AP1) 406-1 transmits a CBF synchronization (SYNC) message 732 to synchronize the DL MU PPDU transmission from both the sharing AP (AP1) 406-1 and the shared AP (AP2) 406-2. Subsequently, as illustrated in FIG. 7, the sharing AP (AP1) 406-1 transmits a downlink (DL) Aggregated MAC Protocol Data Unit (A-MPDU) 740 and the shared AP (AP2) 406-2 transmits a DL A-MPDU 742.

Some implementations of Carrying Extended Time-out Period, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In some embodiments, BSRP and MU-RTS carry extended time-out periods. In some embodiments, BSRP, MU-RTS, and MU-BAR carry extended time-out periods.

In some embodiments, in a Feedback Type field of a Feedback User Info field, a new value is carried to indicate that the Feedback field carries the minimal time out period requirement.

In some embodiments, in a Feedback Information field, bit 0 to B6 (B16 to B22 of Feedback User Info field) or B0 to B7 (B16 to B23 of Feedback User Info field) indicate the minimal time out period requirement in unit of 4 microseconds (μs).

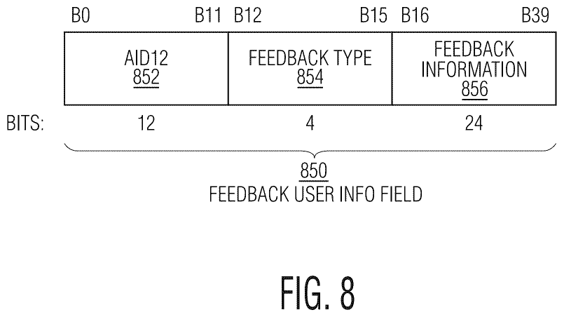

FIG. 8 illustrates a Feedback User information (Info) field format 850 in accordance with example embodiments. The Feedback User Info field format 850 illustrated in FIG. 8 can be used for communications by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4. In the embodiment depicted in FIG. 8, the Feedback User Info field format 850 includes an AID 12 field 852 (e.g., 12 bits) that may carry AID information, a feedback type field 854 (e.g., 4 bits) that may carry feedback type information, and a feedback information field 856 (e.g., 24 bits) that may carry feedback information. In some embodiments, B16 to B22 of Feedback User Info field or B16 to B23 of Feedback User Info field indicate the minimal time out period requirement in unit of 4 microseconds (μs).

Some implementations of Estimation of Extended Time-out Period, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In some embodiments, the extended time-out period selected by a sharing AP (e.g., the sharing AP (AP1) 406-1 depicted in FIG. 4) is used for a STA associated with the sharing AP (e.g., the STA (STA1) 410-1 depicted in FIG. 4) need to at least cover the maximal value of:
time period 1: after an ICR transmitted by the STA (e.g., the STA (STA1) 410-1 depicted in FIG. 4) until its reception of a DL A-MPDU that is decided by a shared AP (e.g., the shared AP (AP2) 406-2 depicted in FIG. 4)'s ICF/ICR exchange(s), CBF Sync and short interframe space (SIFS) slots.

time period 2: after the BA transmission of the STA (e.g., the STA (STA1) 410-1 depicted in FIG. 4) until its reception of the following DL A-MPDU.

In some embodiments, a shared AP (e.g., the shared AP (AP2) 406-2 depicted in FIG. 4) needs to notify its maximal value of the shared AP (e.g., the shared AP (AP2) 406-2 depicted in FIG. 4)'s time for exchanging ICF/ICR initiated by the shared AP and the shared AP (e.g., the shared AP (AP2) 406-2 depicted in FIG. 4)'s time for exchanging MU-BAR/BA initiated by the shared AP. In some embodiments, a sharing AP (e.g., the sharing AP (AP1) 406-1 depicted in FIG. 4)'s maximal value of time period 1 and time period 2 announced by the shared AP (e.g., the shared AP (AP2) 406-2 depicted in FIG. 4) is carried in a Feedback Per AID TID Info field.

In some embodiments, the extended time-out period selected by the shared AP (e.g., the shared AP (AP2) 406-2 depicted in FIG. 4) is used for a STA associated with the shared AP (e.g., the STA (STA2) 410-2 depicted in FIG. 4) need to at least cover:
Time-out period candidate 1: after ICR transmitted by the STA associated with the shared AP (e.g., the STA (STA2) 410-2 depicted in FIG. 4) until its reception of DL A-MPDU that is decided by a CBF Sync and the SIFS slots (the STA associated with the shared AP (e.g., the STA (STA2) 410-2 depicted in FIG. 4) may estimate this very closely);
Time-out period candidate 2: after CBF simultaneous transmitted PPDUs until it's the reception of soliciting BAR (MU-BAR);
Time-out period candidate 3: after the BA transmission of the STA associated with the shared AP (e.g., the STA (STA2) 410-2 depicted in FIG. 4) until its reception of the following DL A-MPDU (STA2 may estimate this very closely) if exists, which may be decided by Invite/Response CBF Sync and the SIFS slots; the value 0 if following DL A-MPDU does not exist.

In some embodiments, a sharing AP (e.g., the sharing AP (AP1) 406-1 depicted in FIG. 4) needs to notify its time for exchanging MU-BAR/BA initiated by the sharing AP in a CBF transmission invite frame.

Some implementations of Multiple CBF DL PPDU Transmission Support, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

In some embodiments, an ICF carries the time of extended time-out period. In some embodiments, an ICF, and an MU-BAR carry the time of extended time-out period.

In some embodiments, an EMLSR STA (DPS STA) will not switch back to a listening mode (low-capacity (LC) mode) within the extended time-out period with one of the following exceptions:
a frame addressed to it is received;
the Transmit opportunity (TXOP) ends;
a Contention Free (CF)-End is received.

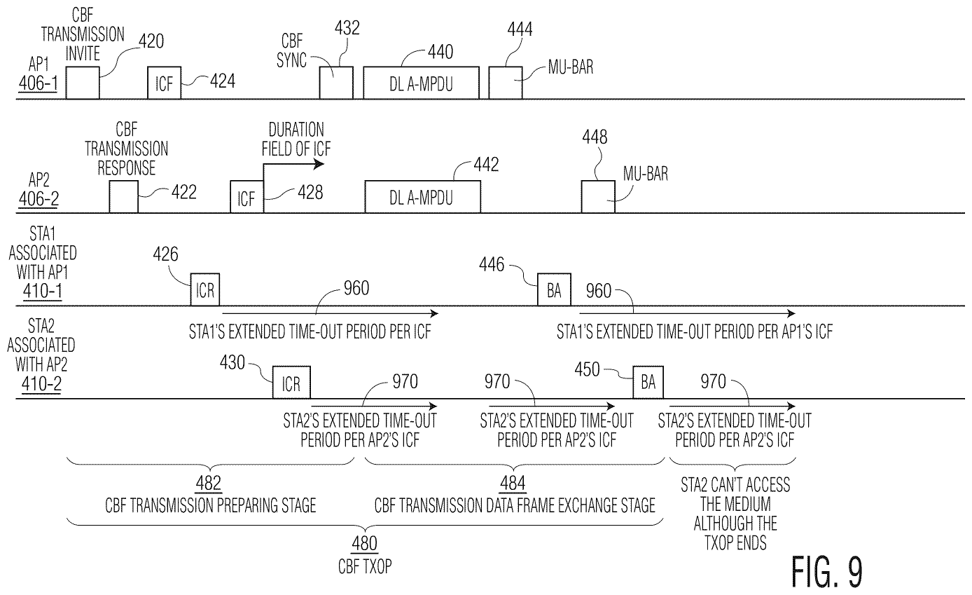

FIG. 9 illustrates some extended time-out periods 960, 970 of the STA (STA1) 410-1 and the STA (STA2) 410-2 depicted in FIG. 4 in accordance with example embodiments. As illustrated in FIG. 9, the sharing AP (AP1) 406-1's ICF 424 (e.g., a BSRP Trigger or an MU-RTS as the ICF) announces the STA (STA1) 410-1's extended time-out period (e.g., carried in a special User Info field, for example, with >2007 value, in its AID12 field) and the STA (STA1) 410-1's extended time-out period 960 is set per the sharing AP (AP1) 406-1's ICF 424, when the STA (STA1) 410-1 finishes the transmission of the ICR 426 (e.g., embedded or carried in a TB PPDU) to the sharing AP (AP1) 406-1 or when the STA (STA1) 410-1 finishes the transmission of the BA 446. The shared AP (AP2) 406-2's ICF 428 (e.g., a BSRP Trigger or an MU-RTS as the ICF) announces the STA (STA2) 410-2's extended time-out period (e.g., carried in a special User Info field, for example, with >2007 value, in its AID12 field) and the STA (STA2) 410-2's extended time-out period 970 is set per the shared AP (AP2) 406-2's ICF 428, when the STA (STA2) 410-2 finishes the transmission of the ICR 430 (e.g., embedded or carried in a TB PPDU) to the shared AP (AP2) 406-2, when STA2 410-2 finishes the reception of DL-AMPDU 442, or when STA2 410-2 finishes the transmission of BA 450. As illustrated in FIG. 9, the STA1 410-1 and STA2 410-2 cannot access the medium although the CBF TXOP 480 ends.

In some embodiments, if/when there is no further CBF transmission, the sharing AP sends a CF-End.

In some embodiments, if/when the shared AP receives the CF-End, the shared AP sends a CF-End.

In some embodiments, the STAs reset their extended timeout timers after receiving the CF-End, which is useful when ICF's extended time-out period is applied to acknowledgement.

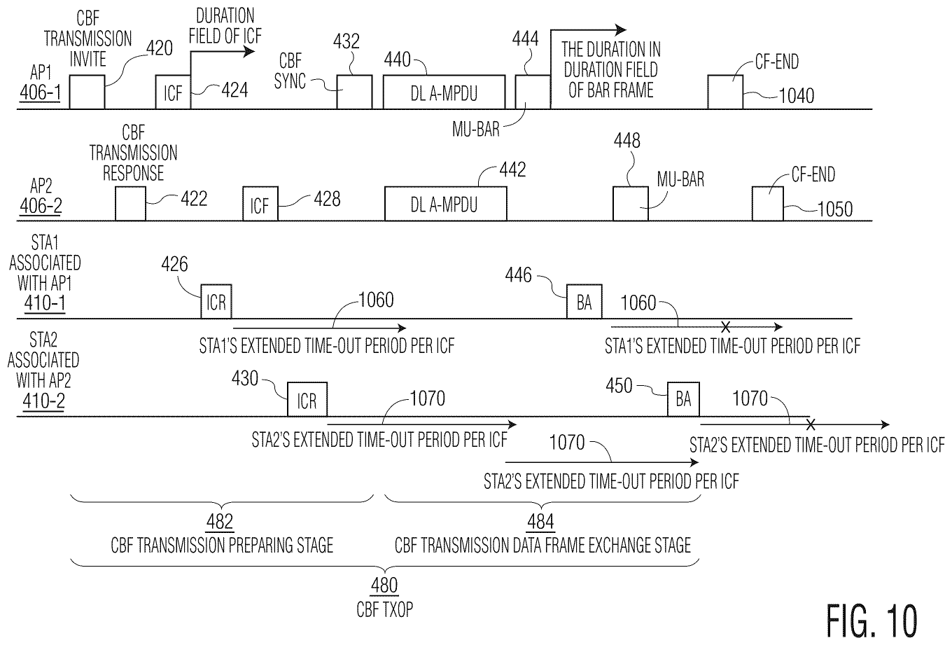

FIG. 10 illustrates some extended time-out periods 1060, 1070 of the STA (STA1) 410-1 and the STA (STA2) 410-2 depicted in FIG. 4 in accordance with example embodiments. As illustrated in FIG. 10, the sharing AP (AP1) 406-1's ICF 424 (e.g., a BSRP Trigger or an MU-RTS as the ICF) announces the STA (STA1) 410-1's extended time-out period (e.g., carried in a special User Info field, for example, with >2007 value, in its AID12 field) and the STA (STA1) 410-1's extended time-out period 1060 is set per the sharing AP (AP1) 406-1's ICF 424, when the STA (STA1) 410-1 finishes the transmission of the ICR 426 (e.g., embedded or carried in a TB PPDU) to the sharing AP (AP1) 406-1 and when STA1 410-1 finishes the transmission of BA 446. The shared AP (AP2) 406-2's ICF 428 (e.g., a BSRP Trigger or an MU-RTS as the ICF) announces the STA (STA2) 410-2's extended time-out period (e.g., carried in a special User Info field, for example, with >2007 value, in its AID12 field) and the STA (STA2) 410-2's extended time-out period 1070 is set per the shared AP (AP2) 406-2's ICF 428, after the STA (STA2) 410-2 finishes the transmission of the ICR 430 (e.g., embedded or carried in a TB PPDU) to the shared AP (AP2) 406-2, when STA2 410-2 finishes the reception of the DL A-MPDU 442, or when STA2 410-2 finishes the transmission of BA 450. As illustrated in FIG. 10, the STA (STA1) 410-1 resets its extended timeout timer after receiving a CF-End 1040 from the sharing AP (AP1) 406-1 and the STA (STA2) 410-2 resets its extended timeout timer after receiving a CF-End 1050 from the shared AP (AP2) 406-2.

In some implementations, if/when there is no further CBF transmission, an MU-BAR carries 0 extended time-out period, which is useful when an ICF's extended time-out period is applied after finishing the transmission of a BA.

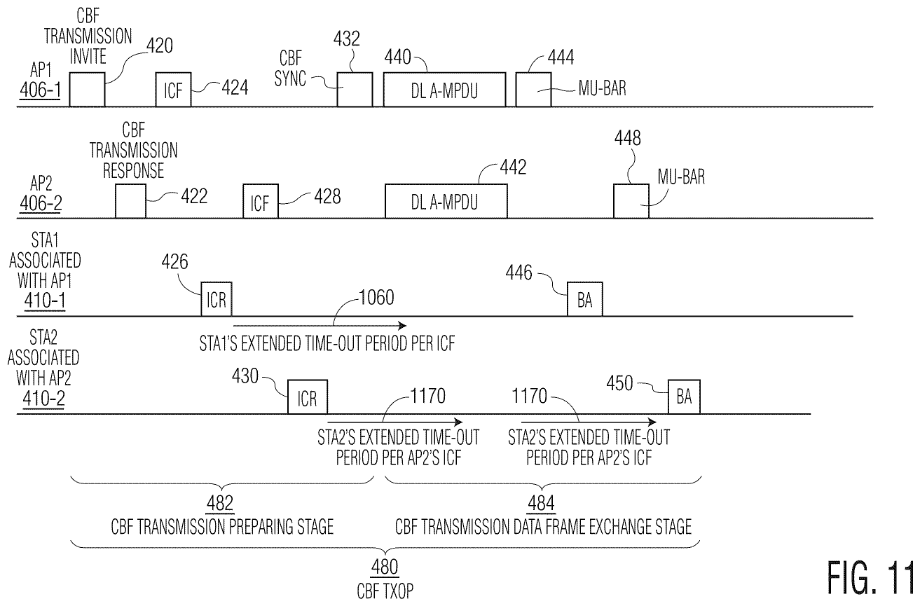

FIG. 11 illustrates some extended time-out periods 1160, 1170 of the STA (STA1) 410-1 and the STA (STA2) 410-2 depicted in FIG. 4 in accordance with example embodiments. As illustrated in FIG. 11, the sharing AP (AP1) 406-1's ICF 424 (e.g., a BSRP Trigger or an MU-RTS as the ICF) announces the STA (STA1) 410-1's extended time-out period (e.g., carried in a special User Info field, for example, with >2007 value, in its AID12 field) and the STA (STA1) 410-1's extended time-out period 1160 is set per the sharing AP (AP1) 406-1's ICF 424, when the STA (STA1) 410-1 finishes the transmission of the ICR 426 (e.g., embedded or carried in a TB PPDU) to the sharing AP (AP1) 406-1. The shared AP (AP2) 406-2's ICF 428 (e.g., a BSRP Trigger or an MU-RTS as the ICF) announces the STA (STA2) 410-2's extended time-out period (e.g., carried in a special User Info field, for example, with >2007 value, in its AID12 field) and the STA (STA2) 410-2's extended time-out period 1170 is set per the shared AP (AP2) 406-2's ICF 428, when the STA (STA2) 410-2 finishes the transmission the ICR 430 (e.g., embedded or carried in a TB PPDU) to the shared AP (AP2) 406-2 and when STA2 410-2 finishes the reception of the DL A-MPDU 442. The MU-BAR 444 carries 0 extended time-out period, and when/after receiving the MU-BAR 444, the STA (STA1) 410-1 resets its extended time-out period to zero. The MU-BAR 448 carries 0 extended time-out period, and when/after receiving the MU-BAR 448, the STA (STA1) 410-2 resets its extended time-out period to zero.

Some implementations of setting Duration field in soliciting frame for Network Allocation Vector (NAV) setting and Virtual Carrier Sensing under CBF, for example, by the wireless communications system 100 depicted in FIG. 1, the AP/STA of the multi-link (ML) communications system 200 in a link depicted in FIG. 2, the wireless device 300 depicted in FIG. 3, and/or the sharing AP (AP1) 406-1, the shared AP (AP2) 406-2, the STA (STA1) 410-1, and/or the STA (STA2) 410-2 depicted in FIG. 4 are described.

Some examples of durations of CBF Transmission Invite, CBF Sync frame and DL MU joint transmission are described as follows.

In some embodiments, if/when a frame carries both an inviting/sharing AP's MAC address and an invited/shared AP's MAC address in its MAC header and is in a non-HT (High Throughput) duplicate PPDU, the Duration in the frame's MAC header will be used to set the intra-BSS NAV timer of all the TXOP responders of a CBF TXOP. In some embodiments, a CBF Transmission Invite and a CBF Transmission Response satisfy such requirement. In some embodiments, a CBF Sync frame satisfies such requirement. In some embodiments, a CBF Transmission Invite needs at least to carry the TXOP duration long enough to cover the inviting/sharing AP's CBF Sync frame. In some embodiments, since the PHY header of DL joint transmission and the carried A-MPDU, e.g., DL A-MPDUs 440 and 442 in FIG. 11, by the sharing AP and the shared AP include the information addressed to both the sharing AP and the shared AP, the Duration in a MAC header and the TXOP in a PHY header are not used to set the addressed STAs'NAV timers. The Duration in a MAC header and the TXOP in a PHY header can set the time at least until the end of the BA transmitted by the STA associated with the shared AP or until the end of the TXOP.

In some embodiments, the Duration in a CBF Transmission Invite needs be set to a value no earlier than the time to transmit the inviting AP's CBF Sync frame, e.g., indicating the end time of the TXOP.

In some embodiments, the Duration in a CBF Sync needs to be set to a value at least covering the end of the shared AP's acknowledgement, e.g., indicating the end time of the TXOP. In some embodiments, if/when there is following CBF transmission, the Duration in the CBF Sync needs to be set to a value at least covering the following CBF Invite.

Some examples of durations of soliciting frames other than the CBF Transmission Invite and CBF Sync frame are described as follows. Only one address (e.g., transmitter address (TA)) in a MAC header of each of such soliciting frames is either the sharing AP's MAC address or the shared AP's MAC address.

In some embodiments, the time duration defined by the Duration field of a soliciting frame transmitting one of a sharing AP and a shared AP does not cover the time when (or the time SIFS before) another of a sharing AP and a shared AP transmits its soliciting frame that solicits a response. In some embodiments, the time duration defined by the Duration field of a soliciting frame transmitting one of a sharing AP and a shared AP does not cover the time when (or the time SIFS before) another of a sharing AP and a shared AP transmits its soliciting frame that solicits a response where before transmitting the response the clear channel assessment (CCA) is required at the responding STA. In some embodiments, the time duration defined by the Duration field of a soliciting frame transmitting by a sharing AP does not cover the time when (or the time SIFS before) a shared AP transmits its soliciting frame that solicits a response. In some embodiments, in a variant, the time duration defined by the Duration field of a frame transmitting by the sharing AP does not cover the time when (or the time SIFS before) the STA associated with the shared AP transmits its frame solicited by the shared AP that needs the carrier sensing before transmitting the response.

In some embodiments, the time duration defined by the Duration field of a soliciting frame transmitted by a shared AP cannot cover the time when (or the time Short Inter-frame Spacing (SIFS) before) a sharing AP transmits its frame that solicits a response. In some embodiments, in a variant, the time duration defined by the Duration field of a frame transmitting by the shared AP does not cover the time when (or the time SIFS before) the STA associated with the sharing AP transmits its frame solicited by the sharing AP that needs the carrier sensing before transmitting the response.

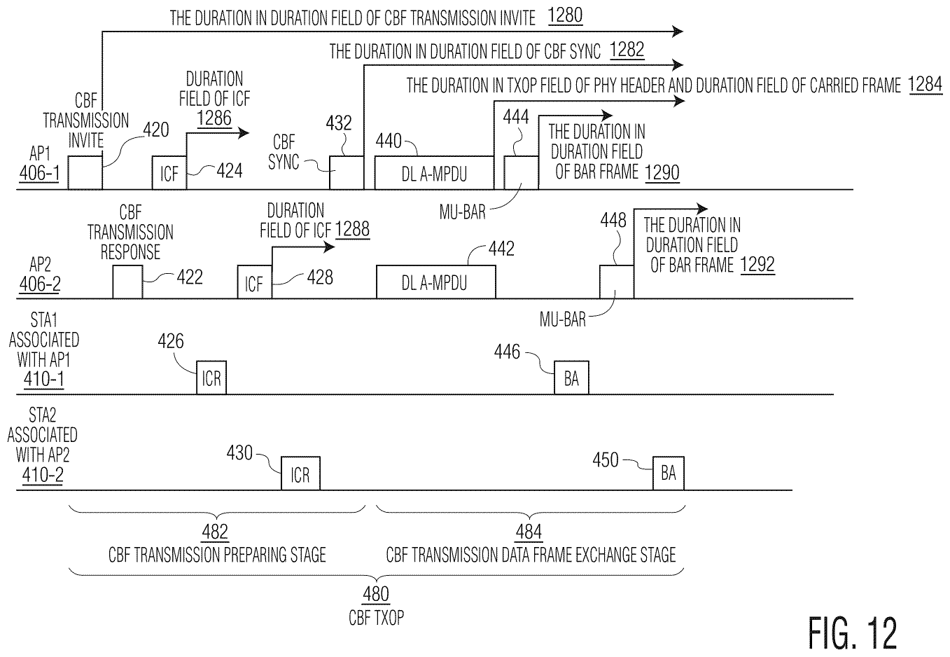

FIG. 12 illustrates some TXOP durations 1280, 1282, 1284, 1286, 1288, 1290, 1292 set by the sharing AP (AP1) 406-1 and the sharing AP (AP2) 406-2 in the CBF TXOP 480 depicted in FIG. 4 in accordance with example embodiments. As illustrated in FIG. 12, the duration 1280 in the Duration field of the CBF Transmission Invite 420 has a length that can cover frame exchanges at least until the CBF SYNC frame 432 transmission (e.g. to the end of the TXOP as shown in the figure). The Duration of a responding CBF Transmission Response 422 frame is not shown in FIG. 12 since the end time indicated by the Duration field in the responding frame, i.e., the CBF Transmission Response 422, is the same as the ending time indicated by the soliciting frame, i.e., the CBF Transmission Invite 420. In some embodiments, the duration 1286 in the Duration field of the ICF 424 has the length that covers the end of the ICR 426 or no late than the beginning of the ICF 428. In some embodiments, the duration 1288 in the Duration field of the ICF 428 has the length that cover the end of the ICR 430 or no late than the beginning of the CBF SYNC frame 432. In some embodiments, the duration 1290 in the Duration field of the MU-BAR 444 has the length that cover the end of the BA 446 or no late than the beginning of the MU-BAR 448. In some embodiments, the duration 1292 in the Duration field of the MU-BAR 448 has the length that cover the end of the BA 450.

Some examples of Invited AP consideration are described as follows.

In some embodiments, for an Invited AP's basic NAV timer, in Option 1, the base line rules are applied when the invited AP receives frames from an inviting AP or the STAs associated with the inviting AP.

In some embodiments, for an Invited AP's basic NAV timer, in option 2, the invited AP does not update its basic NAV timer when it receives the frames from the inviting AP.

In some embodiments, a method of conducting CBF frame exchanges between first devices and second devices where at least one second device is associated with each first device includes announcing, by the sharing first device through the exist Trigger variant frame, the simultaneous DL PPDU transmission to the shared first device and transmitting, by the two first devices, the DL PPDU SIFS after the announcing frame. In some embodiments, the existing Trigger frame is a BSRP NTB Trigger frame or an MU-RTS with the reserved bit in Common Info field or IEEE 802.11be's Special User Info field to be repurposed to indicate CBF Sync purpose. In some embodiments, the User Info field with shared AP's ID allocated by sharing AP carries the Tx parameters for CBF PPDU transmission and the Tx parameters for second device associated with shared first device to transmit TB PPDU. In some embodiments, the User Info field with a value more than 2007 in its AID 12 field carries the Tx parameters for CBF PPDU transmission and the Tx parameters for second device associated with shared first device to transmit TB PPDU. In some embodiments, sequential acknowledgement is used for acknowledge the joint/simultaneous DL transmission from the sharing AP and the shared AP, e.g., the MU-BAR 444, the BA 446, the MU-BAR 448, and the BA 450. In some embodiments, the sharing first device transmits CBF PPDU carrying QoS Data frame(s) with Ack Policy equal to High Throughput PHY Acknowledgement (HTP Ack) (01), and the shared first device transmits CBF PPDU carrying QoS Data frame(s) with Ack Policy equal to HTP Ack (01). In some embodiments, the CBF SYNC frame (e.g., BSRP NTB Trigger frame or MU-RTS) with the reserved bit in Common Info field or IEEE 802.11be's Special User Info field to is repurposed to indicate whether the sharing AP transmits MU-BAR after the joint DL PPDU transmission.

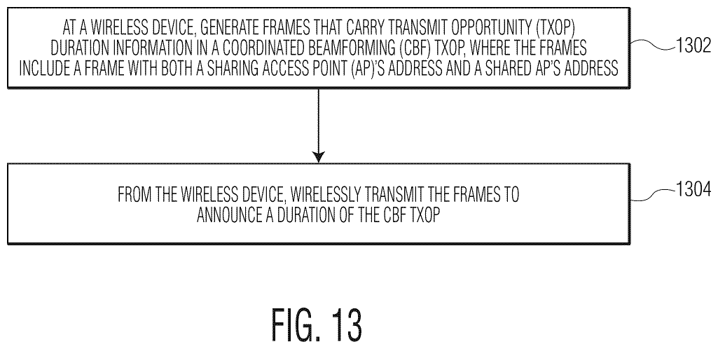

FIG. 13 is a process flow diagram of a method for wireless communications in accordance with an embodiment of the disclosure. At block 1302, at a wireless device, frames that carry transmit opportunity (TXOP) duration information in a coordinated beamforming (CBF) TXOP are generated, where the frames includes a frame with both a sharing access point (AP)'s address and a shared AP's address. At block 1304, from the wireless device, the frames are wirelessly transmitted to announce a duration of the CBF TXOP. In some embodiments, the frame includes a CBF invite that has its duration field covering at least an end time of transmitting a CBF synchronization (SYNC) frame. In some embodiments, the frame includes a CBF synchronization (SYNC) frame that has its duration field covers an end of the CBF TXOP. In some embodiments, the CBF SYNC frame includes a buffer status report poll (BSRP) non-trigger based (NTB) frame. In some embodiments, the frames include an initial control frame (ICF) addressed to at least one associated station (STA) that has a duration field to cover an end time of transmitting an initial control reply (ICR) frame. In some embodiments, the ICF is transmitted if the at least one addressed STA is an enhanced multi-link single radio (EMLSR) STA or a dynamic power save (DPS) STA to be in a high-capacity (HC) mode for a CBF operation. The wireless device may be the same as or similar to an embodiment of the AP 106 depicted in FIG. 1, the APs 206-1, 206-2 depicted in FIG. 2, the wireless device 300 depicted in FIG. 3, and/or the sharing AP (AP1) 406-1 and/or the shared AP (AP2) 406-2 depicted in FIG. 4.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the disclosure may be implemented entirely in hardware or in an implementation containing both hardware and software elements. In embodiments which use software, the software may include but is not limited to firmware, resident software, microcode, etc.

Although specific embodiments of the disclosure have been described and illustrated, the disclosure is not to be limited to the specific forms or arrangements of parts so described and illustrated. The scope of the disclosure is to be defined by the claims appended hereto and their equivalents.

What is claimed is:

1. A wireless device comprising:
a controller configured to generate a plurality of frames that carry transmit opportunity (TXOP) duration information in a coordinated beamforming (CBF) TXOP, wherein the frames comprise a frame with both a sharing access point (AP)'s address and a shared AP's address; and
a wireless transceiver configured to wirelessly transmit the frames to announce a duration of the CBF TXOP.

2. The wireless device of claim 1, wherein the frame comprises a CBF invite that has its duration field covering at least an end time of transmitting a CBF synchronization (SYNC) frame.

3. The wireless device of claim 1, wherein the frame comprises a CBF synchronization (SYNC) frame that has its duration field covers an end of the CBF TXOP.

4. The wireless device of claim 3, wherein the CBF SYNC frame comprises a buffer status report poll (BSRP) non-trigger based (NTB) frame.

5. The wireless device of claim 1, wherein the frames comprise an initial control frame (ICF) addressed to at least one associated station (STA) that has a duration field to cover an end time of transmitting an initial control reply (ICR) frame.

6. The wireless device of claim 5, wherein the ICF is transmitted if the at least one addressed STA is an enhanced multi-link single radio (EMLSR) STA or a dynamic power save (DPS) STA to be in a high-capacity (HC) mode for a CBF operation.

7. The wireless device of claim 6, wherein the ICF carries an extended time-out period.

8. The wireless device of claim 7, wherein the extended time-out period is carried in a special user information (Info) field.

9. The wireless device of claim 8, wherein the special user Info field has a value that is higher than 2007.

10. The wireless device of claim 1, wherein the frames comprise a multi-user (MU)-block acknowledgement request (BAR) addressed to at least one associated station (STA) has a duration field to cover an end time of transmitting a block acknowledgement (BA) frame.

11. The wireless device of claim 10, wherein the MU-BAR carries an extended time-out period.

12. The wireless device of claim 11, wherein the extended time-out period is carried in a feedback per Association Identifier (AID) Traffic Identifier (TID) information (Info) field.

13. The wireless device of claim 7, wherein the sharing AP transmits a contention free-end (CF-End) frame to instruct a station (STA) associated with the sharing AP to reset a timer of the extended time-out period.

14. The wireless device of claim 13, wherein after receiving the sharing AP's CF-End frame, the shared AP transmits the CF-End frame to instruct a STA associated with the shared AP to reset a timer of the extended time-out period.

15. A method for wireless communications, the method comprising:
at a wireless device, generating a plurality of frames that carry transmit opportunity (TXOP) duration information in a coordinated beamforming (CBF) TXOP, wherein the frames comprise a frame with both a sharing access point (AP)'s address and a shared AP's address; and
from the wireless device, wirelessly transmitting the frames to announce a duration of the CBF TXOP.

16. The method of claim 15, wherein the frame comprises a CBF invite that has its duration field covering at least an end time of transmitting a CBF synchronization (SYNC) frame.

17. The method of claim 15, wherein the frame comprises a CBF synchronization (SYNC) frame that has its duration field covers an end of the CBF TXOP.

18. The method of claim 17, wherein the CBF SYNC frame comprises a buffer status report poll (BSRP) non-trigger based (NTB) frame.

19. The method of claim 15, wherein the frames comprise an initial control frame (ICF) addressed to at least one associated station (STA) that has a duration field to cover an end time of transmitting an initial control reply (ICR) frame.

20. The method of claim 19, wherein the ICF is transmitted if the at least one addressed STA is an enhanced multi-link single radio (EMLSR) STA or a dynamic power save (DPS) STA to be in a high-capacity (HC) mode for a CBF operation.
